(19) United States
(12) Patent Application Publication
(10) Pub. No.: US 2005/0245136 A1
(43) Pub. Date: Nov. 3, 2005

(54) Memory card connector with metal cover and ground terminals

(76) Inventors: Hao Yin, Shanghi (CN); Hongjun Yin, Singapore (SG)

Correspondence Address: MOLEX INCORPORATED, 2222 WELLINGTON COURT, LISLE, IL, 60532, US

(21) Appl. No.: 11/115,570

(22) Filed: Apr. 27, 2005

(30) Foreign Application Priority Data
Apr. 29, 2004 (CN) 200420050516.9
Apr. 29, 2004 (CN) 200420050515.4
Apr. 29, 2004 (CN) 200420050514.X
Apr. 29, 2004 (CN) 200420050513.5

(51) Int. Cl. H01R 24/00

(52) U.S. Cl. 439/630

(57) ABSTRACT

A memory card connector is provided for receiving a memory card having a plurality of conductive contacts. The connector includes an insulative housing mounting a plurality of conductive signal terminals and at least one ground terminal. A metal cover is provided with a receptacle for receiving the memory card. A pivot mechanism is engageable between the cover and the housing to mount the cover for pivotal movement between an open position to allow the memory card to be inserted into the receptacle and a closed and latched position bringing the contacts of the memory card into engagement with the signal terminals on the housing and bringing the metal cover into engagement with the ground terminal.

### FIELD OF THE INVENTION

This invention generally relates to the art of electrical connectors and, particularly, to a memory card connector having a hinged metal cover which is grounded to ground terminals on the connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs. cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

FIG. 1 shows a prior art memory card connector, generally designated 10, which includes an insulative base housing or terminal module 12 and an upper cover, generally designated 14, hinged or pivoted to the housing by hinge means 16. The cover may comprise a metal shell 18 and a pair of side arms 20. Housing 12 includes a plurality of terminal-receiving slots 22 which mount a plurality of conductive terminals 24. Pivot means 16 include pivot shafts within arms 20 which are inserted into pivot holes (not visible in the drawing) at the rear of housing 12. The pivot means mounts the cover to the housing for pivotal movement between an open position (as shown) to allow a memory card (not shown) to be mounted at the underside of the cover, and a closed position bringing contacts of the memory card into engagement with terminals 24. Although shown somewhat schematically, housing 12 includes a locking fastener 26 for engaging a locking clasp 28 on the cover to hold the cover in its closed position.

Although memory card connectors 10 of the prior art may be satisfactory for some purposes, some memory card connectors have ground terminals grounded to a printed circuit board. The present invention is directed to an improved memory card connector wherein a metal cover for the connector is moved into engagement with the ground terminals automatically when the cover is moved to a closed and latched position on the connector housing.

### SUMMARY OF THE INVENTION

An object, therefore, of the invention is to provide a new and improved memory card connector having a metal cover grounded to ground terminals of the connector.

In the exemplary embodiment of the invention, a memory card connector is provided for receiving a memory card having a plurality of conductive contacts. The connector includes an insulative housing mounting a plurality of conductive signal terminals and at least one ground terminal. A metal cover is provided with receptacle means for receiving the memory card. Pivot means are engageable between the cover and the housing to mount the cover for pivotal movement between an open position to allow the memory card to be inserted into the receptacle means and a closed and latched position bringing the contacts of the memory card into engagement with the signal terminals on the housing and bringing the metal cover into engagement with the ground terminal.

According to one embodiment of the invention, the metal cover includes a top wall and at least one side wall. The ground terminal is engageable with the side wall when the metal cover is in its closed and latched position. The ground terminal includes a fixing portion for mounting the ground terminal in the housing and a flexible contact arm for engaging the side wall of the metal cover in a direction generally parallel to the top wall of the cover. The ground terminal may also include a solder portion for soldering the ground terminal to a ground trace on an appropriate printed circuit board. In the preferred embodiment, the metal cover includes a pair of the side walls at opposite sides of the top wall for engaging a pair of ground terminals mounted at opposite sides of the housing.

According to another embodiment of the invention, the metal cover includes a top wall and at least one latching flange depending from one side of the top wall to latch the cover to the housing. The ground terminal is engageable with the latching flange when the metal cover is in its closed and latched position. The ground terminal includes a fixing portion for mounting the ground terminal in the housing and a flexible contact arm for engaging a latching portion of the latching flange in a direction generally perpendicular to the top wall of the metal cover. The ground terminal may also include a solder portion for soldering the ground terminal to a ground trace on an appropriate printed circuit board. In the preferred embodiment, the metal cover includes at least one of the latching flanges depending from each of two opposite sides of the top wall of the cover for engaging a pair of ground terminals mounted at opposite sides of the housing.

As disclosed herein, the pivot means between the cover and the housing comprises first and second sockets in one of the metal cover or housing for receiving a pivot projection on the other of the cover or housing. The first socket forms a pivot socket for pivoting the cover from its open position and a closed position. The second socket allows the cover to slidably move from the closed position to a latched position. A detent is provided between the two sockets over which the pivot projection “snaps” to give an audible and/or tactile indication of the cover moving from its closed position to the latched position.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a memory card connector according to the prior art and described in the Background, above;

FIG. 2 is a perspective view of a memory card connector according to a first embodiment of the invention, with the cover in its open position;

FIG. 3 is a perspective view of one of the ground terminals of the first embodiment;

FIG. 4(a) is a top plan view of the connector, with the cover in its closed position;

FIG. 4(b) is a vertical section taken generally along line A-A in FIG. 4(a);

FIG. 5 is a bottom perspective view of the connector with the cover in the closed position;

FIG. 6 is a bottom perspective view of the connector with the cover slidably moved from the closed position of FIG. 5 to a latched position;

FIG. 7 is a perspective view of a ground terminal according to a second embodiment of the invention;

FIG. 8 is a view similar to that of FIG. 2, but with the connector incorporating ground terminals according to the second embodiment of FIG. 7;

FIGS. 9 and 10 are sequential, vertical sectional views similar to that of FIG. 4(b), but showing the connector of the second embodiment with the cover moved from its closed position (FIG. 9) to its latched position (FIG. 10);

FIG. 11 is a view similar to that of FIG. 2, but with the cover removed to show one embodiment of a pivot means between the cover and the housing;

FIG. 12 is an enlarged side elevational view of the pivot means in FIG. 11; and

FIG. 13 is a view similar to that of FIG. 11, but showing a second embodiment of the pivot means.

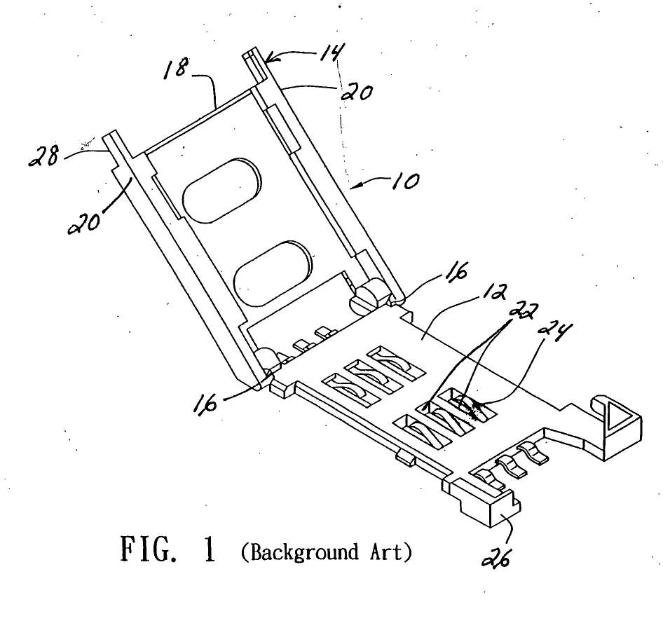

### DETAILED DESCRIPTION OF THE PREFERRED EMBODIMENTS

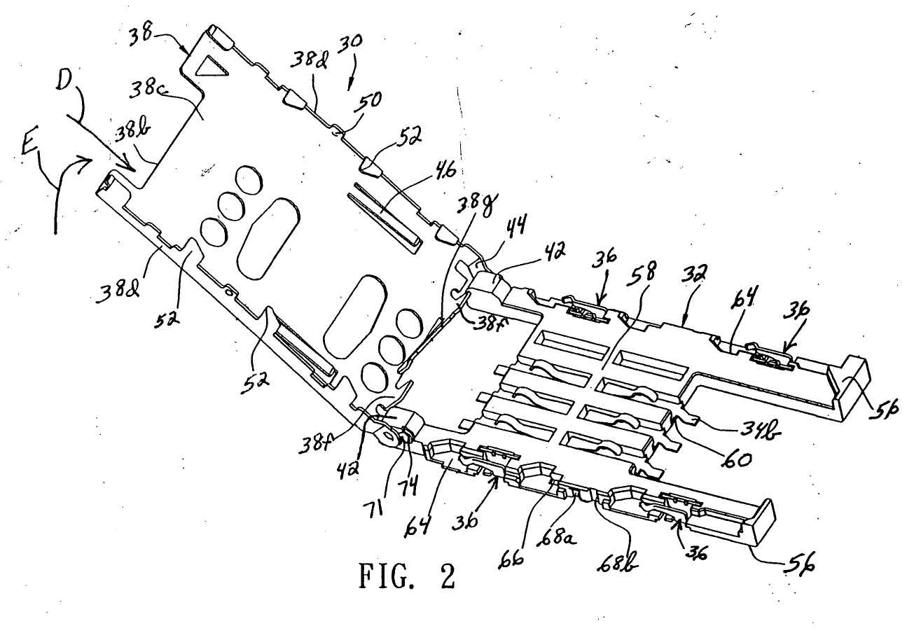

Referring to the drawings in greater detail, and first to FIG. 2, a first embodiment of the invention is incorporated in a memory card connector, generally designated 30, for receiving a memory card (not shown) having a plurality of conductive contacts. The connector includes an insulative body or housing, generally designated 32, which mounts a plurality of signal terminals, generally designated 34, and a plurality of ground terminals, generally designated 36. A cover 38 is pivotally mounted to the housing by a pair of pivot means, generally designated 40, at opposite sides of the connector. The cover is stamped and formed of sheet metal material.

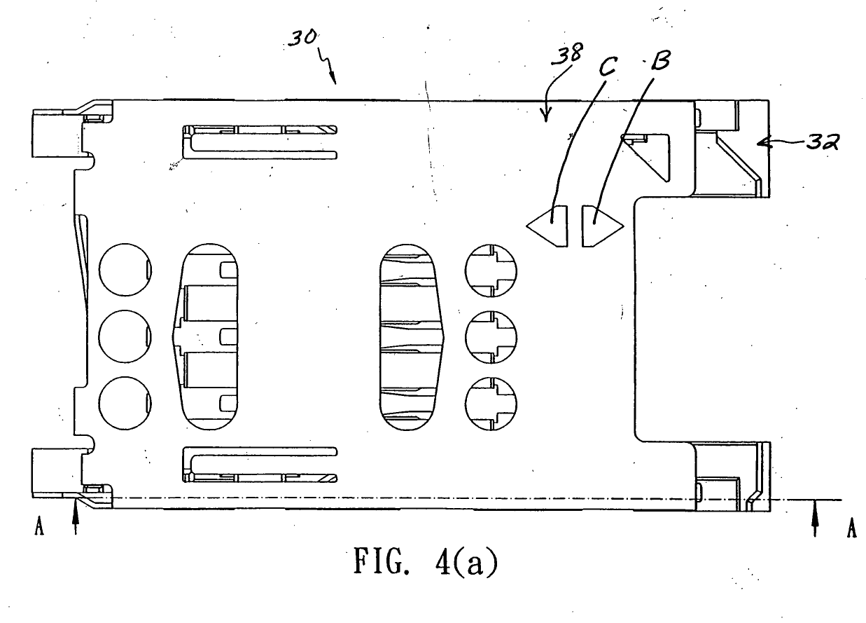

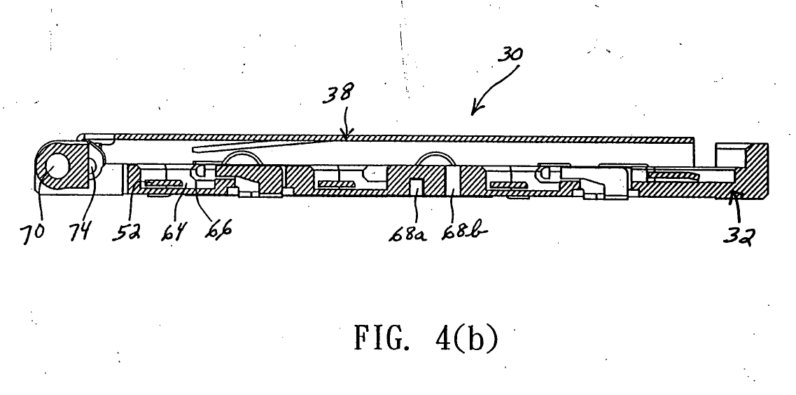

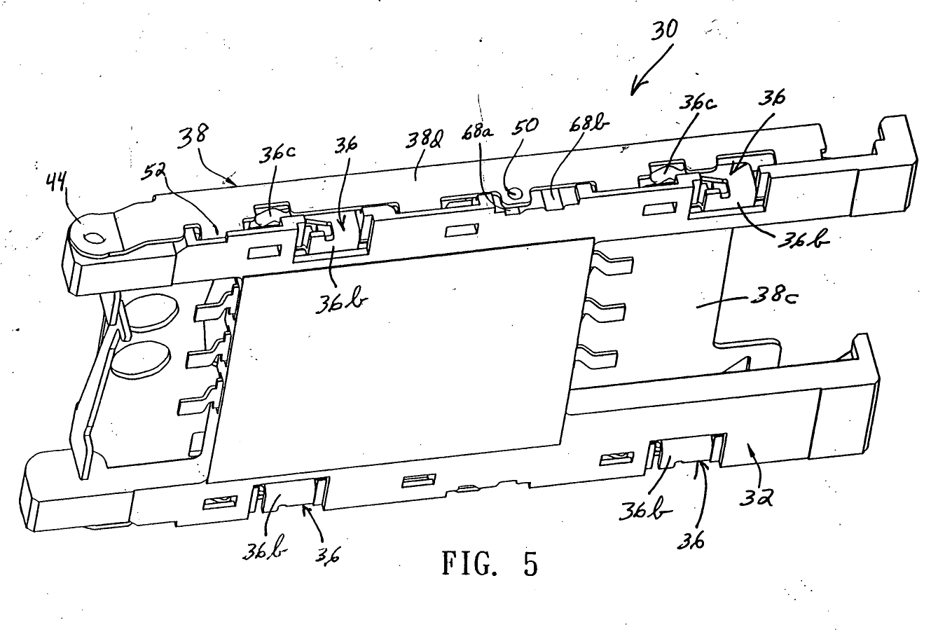

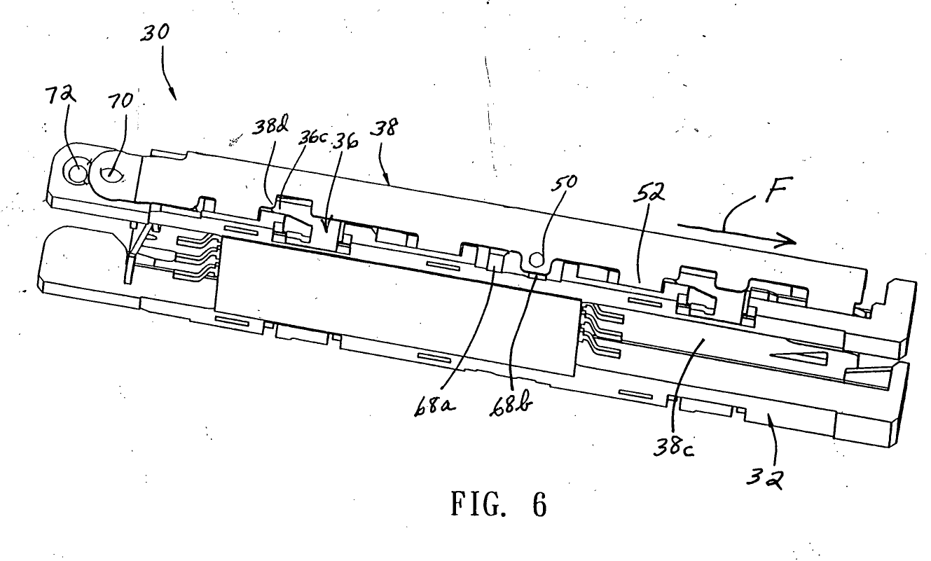

The pivot means 40 generally are provided between a pair of pivot blocks 42 at the rear of housing 32 and a pair of spring arms 44 at the pivot end of the stamped and formed sheet metal cover 38. Therefore, the cover is pivotally mounted to the housing for pivotal movement between an open position (FIG. 2) to allow a memory card to be mounted to the inside of the cover, and a closed position (FIGS. 4(a)-5), bringing the contacts of the memory card into engagement with terminals 34 on housing 32. The pivot means 30 then allows the cover to slidably move from its closed position to a latched position shown in FIG. 6. As will be seen hereinafter, the pivot means performs a function of providing for pivotal movement of the cover between its open and closed position and sliding movement of the cover to its latched position. As seen in FIG. 4(a), the cover is slidably moved on the housing from its closed position to its latched position in the direction of arrow “B”. The cover is slidably moved back to its closed and pivotal position in the direction of arrow “C”.

Still referring to FIG. 2, metal cover 38 includes a pivot end 38a and a memory card insertion end 38b. The cover includes a top wall 38c and a pair of side walls 38d. A flange 38e is bent inwardly from each side wall 38d generally parallel to top wall 38c near insertion end 38b. A pair of bottom flanges 38f are bent generally perpendicular to top wall 38c at pivot end 38a of the cover. An angled, resilient arm 38g extends from one of the bottom flanges across the pivot end of the cover. Therefore, a receptacle means is provided at the underside of cover 38 by top wall 38c, side walls 38d, flanges 38e and bottom flanges 38f. A memory card is inserted into the receptacle means of the cover in the direction of arrow “D” until an end of the memory card engages resilient arm 38g. When the cover is pivoted to its closed and latched position shown in FIG. 6, a pair of spring arms 46 bias the memory card and, thereby, the contacts of the memory card into engagement with terminals 34. Spring arms 46 are stamped and formed out of top wall 38c of the cover.

Other features of the cover include a plurality of holes 48 stamped out of top wall 38c of the cover to allow for visual inspection of solder connections of terminals 34 with a printed circuit board, as will be seen hereinafter. An inwardly directed detent 50 is provided on each side wall 38d of the cover, for purposes described hereinafter. Finally, a plurality of latching flanges 52 are bent inwardly from side walls 38d, again for purposes described hereinafter.

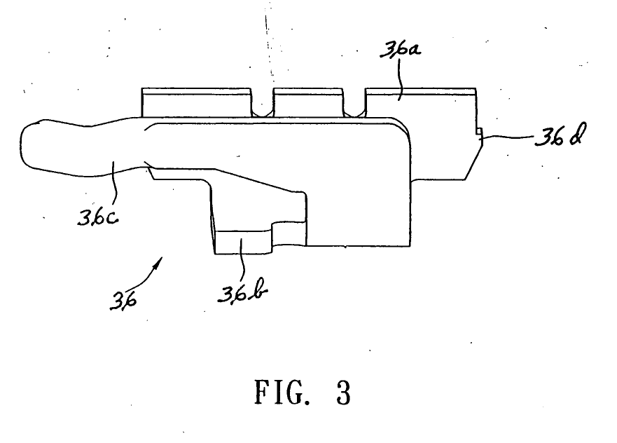

Terminals 34 include contact portions 34a and solder tail portions 34b. The contact portions are engageable with the contacts of the memory card. The solder tail portions are surface connected, as by soldering, to appropriate circuit traces on a printed circuit board. As seen best in FIG. 3, ground terminals 36 have fixing portions 36a, solder pad portions 36b and flexible contact portions 36c. The fixing portions are inserted into mounting slots 54 in the housing to fix the ground terminals to the housing. Solder pad portions 36b are solder connected to appropriate ground traces on the printed circuit board. Contact portions 36c are engageable with latching flanges 52 of cover 38 when the cover is slidably moved in the direction of arrow “B” (FIG. 4(a)) from its closed position to its latched position, as will be described below.

Housing 32 is generally H-shaped and may be a one-piece structure molded of dielectric material such as plastic or the like. The H-shape is formed by a pair of side legs 56 and a transverse portion 58. Terminals 34 are mounted in slots 60 in the transverse portion of the housing. The housing is cut-out, as at 62, to accommodate solder pad portions 36b of ground terminals 36. Three notches 64 are formed along each opposite side of the housing for accommodating latching flanges 52 of the cover when the cover is pivoted to its closed position. A latching shoulder 66 is formed at a front end of each notch. It can be seen best in FIG. 4 that the contact portion 36c of each ground terminal 36 generally is in alignment with one of the latching shoulders 66. Finally, a pair of detent grooves 68a and 68b are formed in each side of housing 32 for interengagement with detents 50 of the cover for purposes described hereinafter.

In operation of connector 30, a memory card is inserted into cover 38 in the direction of arrow “D” (FIG. 2) with the cover in its open position. The cover then is pivoted in the direction of arrow “E” to its closed position on top of housing 32 as shown in FIGS. 4(a)-5. During this movement, latching flanges 52 on the cover drop into notches 64 in the housing.

After the cover is pivoted to its closed position, the cover then is slidably moved relative to the housing in the direction of arrow “F” (FIG. 6) to move the cover from its closed position to a latched position as shown in FIG. 6. During this movement, detents 50 on the cover “snap” from detent grooves 68a to detent grooves 68b at the sides of the housing to give an audible and/or tactile indication of the cover moving from its closed position to its latched position. Detents 50 also help to prevent unintentional sliding movement of the cover back from its latched position to its closed/pivotal position. Of course, the detents can be overcome by manually pushing the cover back in the direction of arrow “C” in FIG. 4(a).

When cover 38 is slidably moved relative to the housing from its closed position to its latched position as comparing FIGS. 5 and 6, latching flanges 52 slide under latching shoulders 66 within recesses 64 of the housing. This positively locks the cover to the housing and prevents the cover from being lifted even by excessive forces. As can be seen in comparing FIGS. 5 and 6, side walls 38d of cover 38 are moved into engagement with contact portions 36c of ground terminals 36. The side walls flex the contact portions inwardly and establish a good contact between the cover and the ground terminals, thereby grounding the terminals to the printed circuit board through solder pad portions 36b of the ground terminals. The contact portions of the ground terminals engage the side walls in a direction generally parallel to top wall 38c of the cover.

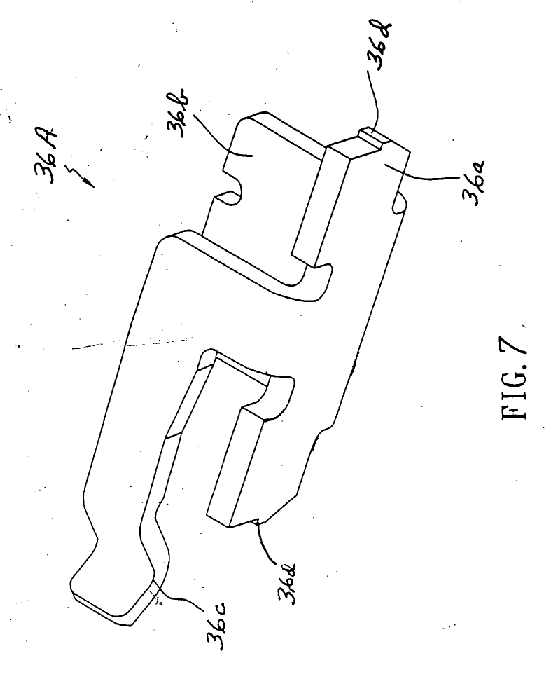

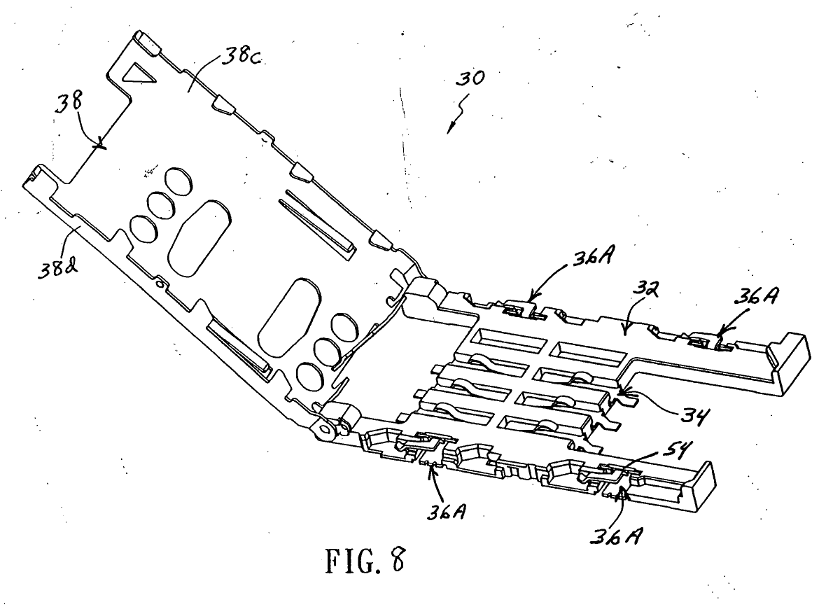

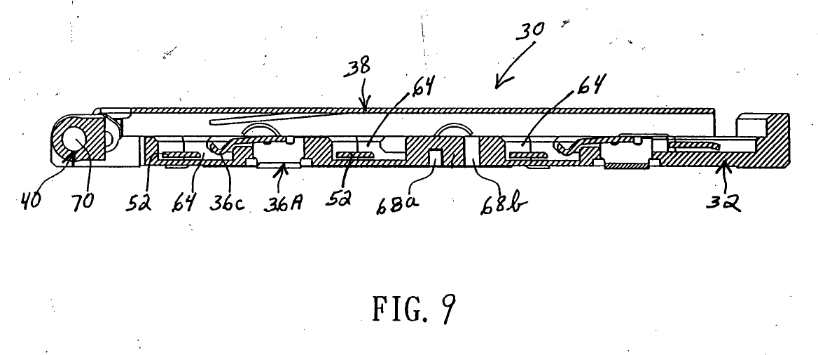

FIGS. 7-10 show a second embodiment of the invention for grounding cover 38 to ground terminals 36. Except for the ground terminals, the cover and housing of the connector shown in FIGS. 7-10 is substantially the same as the connector shown in FIGS. 2-6. Therefore, descriptions of the components thereof will not be repeated, and like reference numerals have been applied in FIGS. 7-10 corresponding to like details described above in relation to the first embodiment.

Specifically, FIG. 7 shows a ground terminal, generally designated 36A, according to the second embodiment. The ground terminal again includes a fixing portion 36a and a solder pad portion 36b. The fixing portion is inserted into one of the mounting slots 54 in the housing, and the fixing portion has teeth 36d for biting into the plastic material of the housing. Terminal 36A also has a flexible contact portion 36c. Ground terminal 36A of the second embodiment is similar to ground terminal 36 of the first embodiment except for the orientation of flexible contact portion 36c. This can be seen by comparing FIG. 7 with FIG. 3. Whereas contact portion 36c of ground terminal 36 of the first embodiment is orientated to engage a side wall of the metal cover, contact portion 36c of terminal 36A of the second embodiment is oriented for engaging one of the latching flanges 52 of the metal cover.

FIG. 8 shows four ground terminals 36A of the second embodiment mounted in housing 32 of the connector, with cover 38 in its open position.

FIG. 9 shows cover 38 pivoted downwardly from its open position of FIG. 8 to its closed position. It can be seen that latching flanges 52 of the cover have moved downwardly into notches 64 at the sides of housing 32. It also can be seen in FIG. 9 that latching flanges 52 are not as yet in engagement with contact portions 36c of ground terminals 36A of the second embodiment.

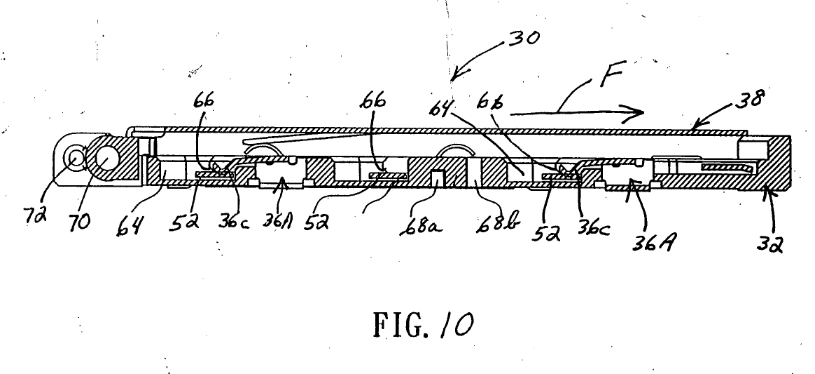

FIG. 10 shows cover 38 slidably moved relative to housing 32 in the direction of arrow “F” from its closed position (FIG. 9) to a latched position. As with the first embodiment, latching flanges 52 slide under latching shoulders 66 within recesses 64 of the housing to positively lock the cover to the housing. In addition, with the second embodiment, latching flanges 62 slide under contact portions 36c of ground terminals 36A of the second embodiment. The latching flanges engage the contact portions and flex the contact portions upwardly to establish a good contact between the cover and the ground terminals. As with the first embodiment, this grounds the cover to the printed circuit board through solder pad portions 36b of the ground terminals.

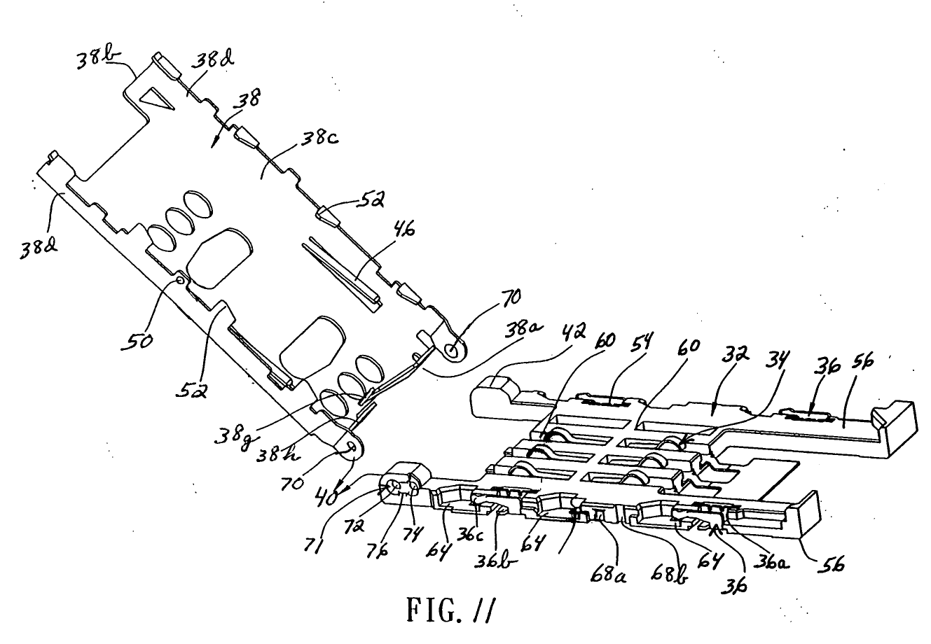

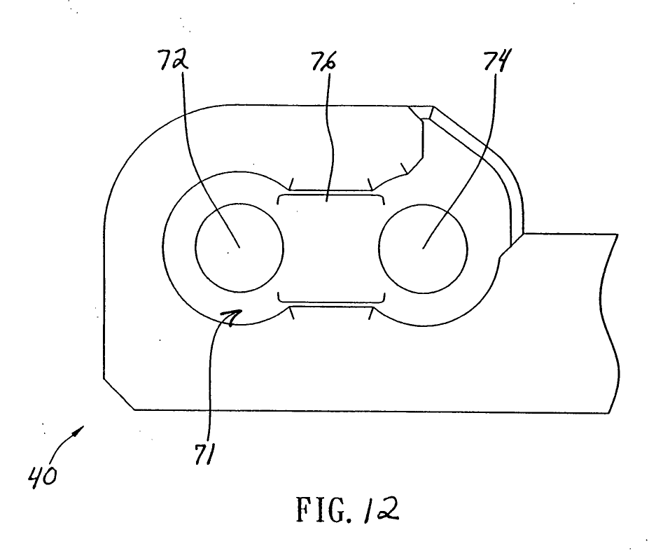

FIGS. 11 and 12 show a first embodiment of the pivot means 40 between spring arms 44 of cover 38 and pivot blocks 42 of housing 32. Specifically, each pivot means includes a conically shaped pivot projection 70 formed in each spring arm 44 and projecting inwardly toward the respective pivot block 42 of the housing. The outside surface of each pivot block is formed with a socket array, generally designated 71, which is comprises of a first circular pivot socket 72 and a second circular socket 74. The first pivot socket receives the respective pivot projection 70 for pivoting the cover from its open position and its closed position. The second socket defines the latched position of the cover when the cover is slidably moved from the closed position to the latched position. The pivot means also includes a raised “bump” or detent 76 formed between sockets 72 and 74. When the pivot projections 70 move from pivot sockets 72 to sockets 74, the pivot projections snap over detents 76 between the two sockets to create a “snapping” action and render an audible and/or tactile indication of the cover moving from its closed position to its latched position. The detents also help to prevent unintentional sliding movement of the cover back from its latched position to its closed/pivotal position.

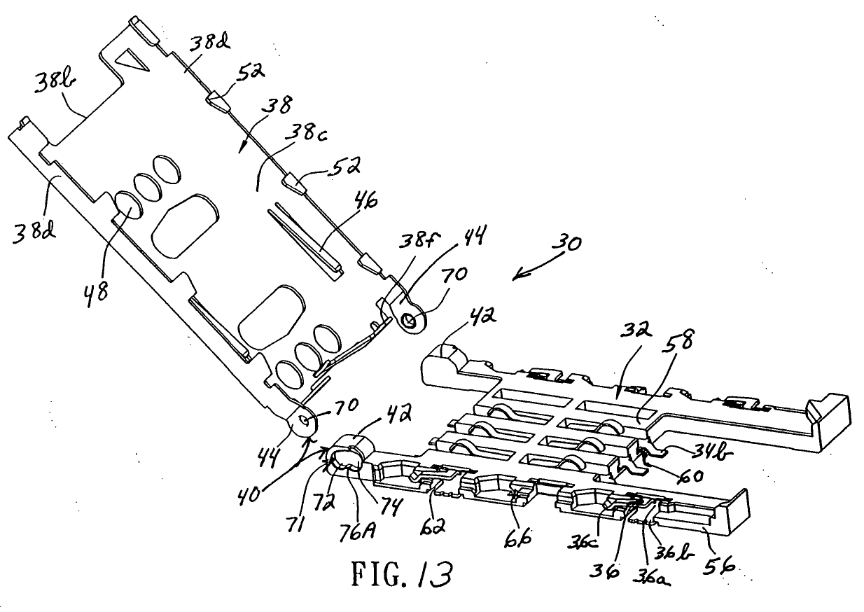

FIG. 13 shows a second embodiment of a pivot means 40 between cover 38 and housing 32. Like the first embodiment, conically shaped pivot projections 70 project inwardly from spring arms 44 of the cover. Again the outside surfaces of pivot blocks 42 are formed with a socket array 71 including a first, pivot socket 72 and a second socket 74. The difference between the socket array in FIG. 13 and the first embodiment described above and shown in FIGS. 11 and 12 is that a detent 76A projects inwardly from the side of the socket array between the two sockets. In other words, the detent “bump” 76 in the first embodiment of FIGS. 11 and 12 projects in a direction generally parallel to the pivot axis of the pivot means, whereas detents 76A of the second embodiment project generally perpendicular to the pivot axis.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for receiving a memory card having a plurality of conductive contacts, comprising:
an insulative housing mounting a plurality of conductive signal terminals and at least one ground terminal;
a metal cover having receptacle means for receiving the memory card;
pivot means engageable between the cover and the housing to mount the cover for pivotal movement between an open position to allow the memory card to be inserted into the receptacle means and a closed and latched position bringing the contacts of the memory card into engagement with the signal terminals on the housing and bringing the metal cover into engagement with the ground terminal.

2. The memory card connector of claim 1 wherein said metal cover includes a top wall and at least one side wall, and the ground terminal is engageable with the side wall when the metal cover is in said closed and latched position.

3. The memory card connector of claim 2 wherein said ground terminal includes a fixing portion for mounting the ground terminal in the housing and a flexible contact arm for engaging the side wall of the metal cover in a direction generally parallel to the top wall of the cover.

4. The memory card connector of claim 3 wherein said ground terminal includes a solder portion for soldering the ground terminal to a ground trace on an appropriate printed circuit board.

5. The memory card connector of claim 2 wherein said metal cover includes a pair of said side walls at opposite sides of the top wall of the cover for engaging a pair of ground terminals mounted at opposite sides of the housing.

6. The memory card connector of claim 1 wherein said metal cover includes a top wall and at least one latching flange depending from one side of the top wall to latch the cover to the housing, and the ground terminal is engageable with the latching flange when the metal cover is in said closed and latched position.

7. The memory card connector of claim 6 wherein said ground terminal includes a fixing portion for mounting the ground terminal in the housing and a flexible contact arm for engaging a latching portion of the latching flange in a direction generally perpendicular to the top wall of the metal cover.

8. The memory card connector of claim 7 wherein said ground terminal includes a solder portion for soldering the ground terminal to a ground trace on an appropriate printed circuit board.

9. The memory card connector of claim 6 wherein said metal cover includes at least one of said latching flanges depending from each of two opposite sides of the top wall of the cover for engaging a pair of ground terminals mounted at opposite sides of the housing.

10. The memory card connector of claim 1 wherein said pivot means comprises first and second sockets in one of the metal cover or housing for receiving a pivot projection on the other of the cover or housing, the first socket forming a pivot socket for pivoting the cover from said open position and a closed position, the second socket allowing the cover to slidably move from the closed position to a latched position, and including a detent between the two sockets over which the pivot projection “snaps” to give an audible and/or tactile indication of the cover moving from the closed position to the latched position.

11. A memory card connector for receiving a memory card having a plurality of conductive contacts, comprising:
an insulative housing mounting a plurality of conductive signal terminals and at least one ground terminal;
a metal cover having receptacle means for receiving the memory card;
pivot means engageable between the cover and the housing to mount the cover for pivotal movement between an open position to allow the memory card to be inserted into the receptacle means and a closed position bringing the contacts of the memory card into engagement with the signal terminals on the housing and to allow the cover to slidably move from the closed position to a latched position; and
interengaging latch means between the metal cover and the housing to prevent the cover from pivoting relative to the housing, including a latching flange on the metal cover slidable under a latching shoulder on the housing when the cover slides to the latched position, the latching flange engaging said ground terminal when the cover is in the latched position.

12. The memory card connector of claim 11 wherein said ground terminal includes a fixing portion for mounting the ground terminal in the housing and a flexible contact arm for engaging a latching portion of the latching flange in a direction generally perpendicular to the top wall of the metal cover.

13. The memory card connector of claim 12 wherein said ground terminal includes a solder portion for soldering the ground terminal to a ground trace on an appropriate printed circuit board.

14. The memory card connector of claim 11 wherein said metal cover includes at least one of said latching flanges depending from each of two opposite sides of the top wall of the cover for engaging a pair of ground terminals mounted at opposite sides of the housing.

15. The memory card connector of claim 11 wherein said pivot means comprises first and second sockets in one of the metal cover or housing for receiving a pivot projection on the other of the cover or housing, the first socket forming a pivot socket for pivoting the cover from said open position and said closed position, the second socket allowing the cover to slidably move from the closed position to said latched position, and including a detent between the two sockets over which the pivot projecting “snaps” to give an audible and/or tactile indication of the cover moving the from the closed position to the latched position.

16. A memory card connector for receiving a memory card having a plurality of conductive contacts, comprising:
an insulative housing mounting a plurality of conductive signal terminals and at least one ground terminal;
a metal cover having a top wall and side walls defining receptacle means for receiving the memory card;
pivot means engageable between the cover and the housing to mount the cover for pivotal movement between an open position to allow the memory card to be inserted into the receptacle means and a closed position bringing the contacts of the memory card into engagement with the signal terminals on the housing and to allow the cover to slidably move from the closed position to a latched position; and
wherein one of said side walls of the metal cover engages the ground terminal when the cover moves to said latched position.

17. The memory card connector of claim 16 wherein said ground terminal includes a fixing portion for mounting the ground terminal in the housing and a flexible contact arm for engaging the side wall of the metal cover in a direction generally parallel to the top wall of the cover.

18. The memory card connector of claim 17 wherein said ground terminal includes a solder portion for soldering the ground terminal to a ground trace on an appropriate printed circuit board.

19. The memory card connector of claim 16 wherein said metal cover includes a pair of said side walls at opposite sides of the top wall of the cover for engaging a pair of ground terminals mounted at opposite sides of the housing.

20. The memory card connector of claim 16 wherein said pivot means comprises first and second sockets in one of the metal cover or housing for receiving a pivot projection on the other of the cover or housing, the first socket forming a pivot socket for pivoting the cover from said open position and said closed position, the second socket allowing the cover to slidably move from the closed position to said latched position, and including a detent between the two sockets over which the pivot projecting “snaps” to give an audible and/or tactile indication of the cover moving the from the closed position to the latched position.
